(19) United States
(12) Patent Application Publication
(10) Pub. No.: US 2006/0112023 A1
(43) Pub. Date: May 25, 2006

(54) Cubing apparatus and methods

(75) Inventors: Jurgen Albert Horhann, Glebe (AU); David Mason McNamee, Balmoral (AU)

Correspondence Address: OLIFF & BERRIDGE, PLC, P.O. BOX 19928, ALEXANDRIA, VA, 22320, US

(73) Assignee: CUBE LOGIC SYSTEMS PROPRIETARY LTD, Glebe (AU)

(21) Appl. No.: 10/523,831

(22) PCT Filed: Apr. 7, 2003
(86) PCT No.: PCT/AU03/00413

§ 371 Date: Nov. 30, 2005

(30) Foreign Application Priority Data
Apr. 9, 2002 (AU) PS 1642
Jun. 13, 2002 (AU) PS 2920

(51) Int. Cl. G01G 19/413; G01F 17/00; G01G 19/40

(52) U.S. Cl. 705/407; 33/1 V; 177/25.15

(57) ABSTRACT

The invention provides dimensional weighing apparatus (5) that may e.g. be placed transparently between the weighing scales (3) and POS terminal (4) of e.g. a postal outlet so as to provide dimensional weighing of a parcel (2). The apparatus (5) senses the parcel height with a sensor (10), and senses the parcel cross-section with a sensor (11) that obtains data points as the parcel (2) rotates on a turntable (12). A control unit (6) determines the parcel volume from the height and cross-section data, and determines a dimensional weight based on the volume and on a minimum chargeable weight per unit volume. It compares the dimensional weight with the actual weight from the scales (3), and outputs the larger value to the POS terminal (4). Various sensor arrangements and profile analyses are described.

The present invention relates to apparatus and methods for the “cubing” or “dimensional weighing” of parcels and the like.

The cost to a postal carrier of delivering a parcel not only depends upon parcel weight, but also upon parcel size. Thus, due to the valuable extra freight space that a large parcel will occupy in a transport vehicle, a lightweight but large parcel will often cost a carrier more to transport than a heavy but small parcel.

To take account of this, carriers use the concept of “dimensional weighting” or “cubing” to calculate customer delivery charges.

In charging systems using this concept, a minimum chargeable weight per unit volume is adopted. A carrier thus determines a parcel's volume, and multiples this by a suitable amount to give a “dimensional weight”, i.e. a minimum charging weight for the parcel. The carrier then compares this value with the actual weight of the parcel, and uses whichever is the heavier to charge the customer, e.g. by multiplying the selected weight by a suitable dollar per unit weight value.

Such systems more accurately reflect the true transport costs of a parcel, are fairer to all, and apply the “user pays” principle.

Unfortunately, however, the actual process of obtaining a dimensional weight can be somewhat cumbersome and time-consuming, and, at present, there is a lack of a practical and effective way of implementing “cubing”, especially in e.g. a busy postal retail setting, such as a post office or the like.

Postal workers, therefore, often find that they are unable practically to implement cubing measurements, and instead merely charge on the basis of a parcel's actual weight. This can lead to significant revenue losses for the postal company/carrier involved.

An aim of the present invention is to provide apparatus and methods for cubing parcels and the like, which are quick and simple to use, and which facilitate the proper charging of parcels at postal retail outlets and the like.

Viewed from one aspect, the present invention provides dimensional weighing apparatus for use with object weighing apparatus and object pricing apparatus, the dimensional weighing apparatus including:

sensing apparatus for determining size data for an object; and

control apparatus which receives size data from the sensing apparatus and which includes an interface for communicating with the weighing apparatus and an interface for communicating with the pricing apparatus;

the control apparatus in use being connected between the weighing and pricing apparatus, and outputting weight information to the pricing apparatus dependent on weight data from the weighing apparatus and size data from the sensing apparatus.

The present invention provides a simple and effective system for automatically determining a dimensional weight for a parcel, which can be used transparently with e.g. scales (weighing apparatus) and cash registers (pricing apparatus) already existing in a postal outlet.

For example, in a typical postal counter set-up, a parcel is placed on a set of scales that then continuously outputs weight data, e.g. in the form of ASCII code, to a point-of-sale terminal, such as a cash register or the like. The cash register then converts the weight data into a corresponding postage charge based on e.g. whether the parcel is for domestic or international carriage or the like.

Using the present invention, the control apparatus may intercept the weight data from the scales, compare this with a dimensional weight determined using the sensing apparatus, and, when deemed necessary, substitute the actual weight with the dimensional weight.

The cash register will therefore always receive the correct parcel weight (either actual or dimensional) for use in its standard calculations for determining postage, and dimensional charging can be effected without change to the standard scales or cash register, and without intervention from the postal worker or retraining of the postal worker.

The cubing system is thus inexpensive and simple to install, as it uses existing equipment and requires no changes to that equipment. It can also provide an immediate increase in revenue to the user, as it enables proper dimensional weight pricing to be performed.

The control apparatus may output the weight data in any form expected by the cash register or the like, e.g. in ASCII code and e.g. in a continuous and repetitious manner.

The interfaces may take any suitable form, as required by the scales and cash register, and could e.g. be in the form of RS232 interfaces.

The sensing apparatus may take any suitable form, and may be provided in any suitable manner.

Preferably, the sensing apparatus is configured to measure the size of the parcel whilst the parcel is on the weighing apparatus, e.g. is sized and shaped to be suitably positioned adjacent and/or over a set of scales. The sensing apparatus defines a measurement area that includes the weighing apparatus therein. The sensing apparatus is preferably self-supporting, and further preferably uses sensors of a non-contact type. Such systems take up minimal extra counter space over that used by the existing scales and register, and a postal worker need only place a parcel on the scales and let the system do the rest. For example, the sensing apparatus could be mounted on a support stand, e.g. comprising a vertical strut and horizontal arm that in use extends over a measurement area. For example, the support could be of an inverted L or J shape.

It should be noted that the present invention would still provide substantial benefits over the present state of affairs, even if sensing were carried out separately from weighing, e.g. at a site adjacent the scales, and even if e.g. sensors were used that were hand-held or needed some human intervention.

The control apparatus may determine the dimensional weight in any suitable manner. It may for example determine the actual volume of the parcel, or it may determine the volume of the parcel assuming that the parcel has a set shape, e.g. cubic, cylindrical, oblong, a regular polyhedron or the like. It may also round dimensions up or down e.g. to the nearest inch, centimetre or the like, or may determine that a parcel is within one of a number of size ranges. In one preferred embodiment, the apparatus determines a minimum sized polyhedron, e.g. a cube or cuboid form, that will enclose the object, and provides a dimensional weight based on the volume of the polyhedron.

The apparatus may use any suitable procedure to determine whether to send the dimensional weight or the actual weight to the cash register, e.g. it may merely determine which is the heavier of the two weights, and output that weight. It could however also implement further decision steps, e.g. only send the dimensional weight when the parcel volume or actual weight is above a set value, or it could send both a dimensional weight and an actual weight, e.g. if a cash register program were suitably modified to receive both.

The sensing apparatus may use any suitable sensors to determine the object size.

In one embodiment, the sensor apparatus may include one or more video and/or digital cameras whose output, after any necessary digitisation, is analysed using suitable feature identification algorithms and the like.

In another embodiment, the sensors sense the distance of the object from them, e.g. in a line-of-sight manner. The sensors may use electromagnetic or acoustic waves to sense the distance to the object. The sensors may comprise for example ultrasonic, microwave or laser sensors, and may measure distance using e.g. time-of-flight or interferometric methods. The transmission and reception portions of a sensor are preferably commonly mounted, although they could be spatially separated.

The sensor outputs may be analogue or digital, and may for example provide an output proportional to the distance to the parcel. The outputs may be biased, e.g. at the sensors or at the control apparatus, e.g. by a suitable voltage or digital value, so as to give a dimension of the object from e.g. the centre or one end of the measurement area, without needing a calculation step of this by the control apparatus.

The number of sensors used and the arrangement of sensors may vary dependent on the type of sensors used, the extent and accuracy to which the object's dimensions are to be determined and the manner in which the object's size is to be calculated.

Preferably, the sensors provide data on at least one cross-sectional profile of the object and at least one height measurement of the object.

The height of the parcel may be determined by one or more overhead sensors arranged substantially vertically over the object, that is with the sensor or sensors being in a downwardly facing orientation.

The cross-sectional data, e.g. a breadth and a width, may be determined by one or more substantially laterally/horizontally-mounted sensors, that is with the sensors being in a laterally/horizontally facing orientation.

Alternative arrangements are also, however, possible for the sensors, and the sensing apparatus could include one or more reflecting elements, e.g. mirrors and/or prisms, so as to direct a sensors beam onto an object to be measured. This can allow the sensor or sensors to be orientated in any suitable direction and position, and provides flexibility in the design of the sensor housing. For example, the height and cross-sectional measurement sensors could be mounted together in a housing that sits in use on a counter top, with the height sensing beam fired upwardly from the housing. This beam could then be reflected down onto the top of the object to be measured from a suitable reflector element or elements, which could for example be mounted on a portion of the ceiling (or to any suitable supporting structure therebetween). This would then provide a compact and simple mounting of the sensors, without the need for a support extending over the object measuring area.

The reflecting elements could take any suitable form. In one form, a single reflector may reflect a sensing beam downwardly onto the top of a measured object. In an alternative arrangement, a pair of reflectors is provided, one deflecting an upwardly aimed beam substantially laterally/horizontally, and the other reflecting this beam downwardly onto the object to be measured. Thus, the reflectors may be arranged opposite to one another and at 45 degrees to the vertical, in a horizontal periscope-type manner. This arrangement has the advantage that the sensing beam is incident on the top of the object in a vertical manner.

The reflecting elements could also be rotated so as to scan a sensing beam across an object.

The cross-sectional data may be taken only from one or two sides of the object, and may provide a cross-sectional area of the object e.g. by assuming that the object is symmetrical, is of a set shape (e.g. rectangular), and is positioned correctly. Preferably, however, the cross-sectional data includes information on laterally/horizontally opposed points on the surface of the parcel, and preferably, this is provided for a full 360-degree profile of the object, i.e. measurements are taken at a number of points about the full periphery of the object. This enables the apparatus to calculate the cross-section of objects that e.g. are not placed at the centre of the sensing area/scales or are of irregular or unexpected cross-section.

Opposing and 360-degree data may be obtained by having a number of sensors positioned about the object, but is preferably achieved by rotating the sensor arrangement and the object relative to one another, with the sensor or sensors taking measurements of the object profile during the rotation.

It is preferred to rotate the object, and to keep the sensor or sensors stationary, although a rotating sensor or sensors (or both a rotating sensor or sensors and a rotating object) would also be possible.

Preferably, the dimensional weighing apparatus includes a turntable on which the object is placed for size determination. The turntable preferably turns the object whilst it is being weighed, and, although the weighing apparatus could be mounted on the turntable, it is preferred to mount the turntable on the weighing apparatus (with a suitable recalibration of the weighing apparatus to take account of the turntable weight).

The turntable may be mounted on the weighing apparatus in any suitable manner, e.g. it could be merely placed on top of a set of scales. It is preferably held in place, e.g. by adhesive, a clamping action, or the like.

The profile is preferably obtained in one cross-section of a parcel using a single, e.g. horizontally oriented, sensor and a rotation of 360 degrees of the parcel. It would also however be possible to use two opposed sensors and a rotation of 180 degrees, three sensors and a rotation of 120 degrees, etc., i.e. “n” sensors and a 360/n degree rotation.

The turntable may rotate in any suitable manner. It could for example be rotated manually, e.g. by a postal worker processing the parcel. The use of a motor is however preferred.

The turntable may be triggered to rotate in any suitable manner, e.g. through a sensor sensing the weight of an object placed on the turntable. Preferably, however, the turntable is connected to the control apparatus, and is activated by a signal from the control apparatus, e.g. when the control apparatus starts to receive a weight signal from the weighing apparatus.

The turntable could rotate by a set angle at a time, e.g. using a stepper motor, and the control unit could take readings from the dimensional sensor or sensors after each step.

Preferably, however, the turntable rotates continuously. In this case, the control apparatus may correlate the sensor readings with the position of the object by monitoring the position of the turntable and by taking sensor readings at set times or angles in the rotation of the turntable.

The turntable position may be monitored by a sensor, such as an optical or magnetic encoder, which outputs a signal at a set angle of revolution of the turntable. The sensor may provide an output, e.g. a pulse, once every set number of degrees of revolution, with sensor readings being taken once every pulse or set number of pulses.

In one embodiment, the turntable is configured to rotate at a constant speed. The control apparatus can then sample the sensor readings at set time intervals and can correlate these to set angular positions of the turntable based on the turntable speed. A rotation sensor may output a signal e.g. once per revolution to indicate when a full 360 degrees rotation has occurred.

Readings may be taken for one rotation, or for two or more rotations. When multiple rotations occur, the results may be averaged or otherwise compared e.g. to increase the accuracy of the measurements.

The turntable may include suitable supports for holding awkwardly shaped parcels in place during rotation. It could for example include a number of holes in its base into which pins or other supports or the like could be placed to hold the parcel.

The turntable may also include one or more guide elements for positioning the parcel on the centre of the scales, although a central location is not essential when a full 360-degree profile of the object is obtained.

The control apparatus may analyse the object profile in any suitable manner in order to determine a volume for the object.

In one embodiment, the apparatus may identify the number of sides of the object through the number of peaks and/or troughs in the profile. The peaks and troughs will generally correspond to corners of the objects or the centres of the sides of the objects. In order to identify the peaks and/or troughs, interpolation, extrapolation and/or curve matching may be needed, as a sensor may not be activated exactly when a corner or wall centre is opposite the sensor.

The control apparatus may determine suitable dimensions of the object cross-section, and/or the objects cross-sectional area, by correlating the dimensional measurements for the peaks and/or troughs, and by using simple geometric techniques. For an oblong shape for example (having four peaks and four troughs), the control apparatus may add the parcel dimensions at alternate peaks in order to obtain the diagonal lengths of the parcel cross-section or add the parcel dimensions at alternate troughs to get the width and breadth.

In another embodiment, the apparatus obtains cross-sectional profile data for the object, and then determines a minimum polygonal form, e.g. a square or rectangle, that will enclose the sensed profile data. The cross-sectional area of this form can then be used to calculate the object volume, e.g. by multiplying the area by the sensed maximum object height to give a minimum volume polyhedron, e.g. a cube or cuboid, within which the object will fit.

The cross-sectional profile data may be analysed in any suitable manner. In one preferred embodiment, the data is organised through a “convex hull” type algorithm. This allows internal body points to be discarded, and determines a convex polygon for the data. Co-linear points are then preferably normalized, which can remove redundancies. A bounding rectangle algorithm is preferably applied to each convex-hull dimension in turn, and the minimum-area bounding rectangle from the resulting bounding rectangles is determined. This minimum-area rectangle is then taken as the minimum polygonal form on which to base the volume calculations, e.g. by multiplying by an object height.

The use of a parcel cross-section and height to determine volume assumes a constant profile for the parcel throughout its height, and this will be true in the vast majority of situations, e.g. where the parcel is a cube, oblong, cylinder or the like. Even when this is not the case, pricing structures often require charging based on the minimum cubic shape that would enclose the parcel (which can be determined from the maximum width, height and breadth of the parcel). The above methods can therefore provide the correct dimensional weight for such pricing structures.

The cubing apparatus could provide horizontal sensors at a number of different heights above the scales, so as to provide a profile of the object at each of these heights. This could provide a more accurate measurement of irregular shaped objects, and would allow the largest cross-section to be used in the price calculations or would allow a more accurate determination of the actual volume of the parcel by using all of the profiles.

If a number of horizontal sensors are used one above the other, then parcel height could be determined by the height of the lowest sensor that did not register the parcel. This could remove the need for a specific, e.g. overhead, height sensor, if for example the horizontal sensors were spaced sufficiently closely to provide suitable height resolution.

In a further alternative, the apparatus could use a number of overhead sensors, e.g. in a linear array, e.g. along a radius of the measuring area. Also, the use of a number of vertical sensors could be used to provide the required horizontal profile of the object, and so could take the place of the horizontally oriented sensor or sensors. With a rotating parcel and/or rotating sensors, the overhead array would only need to extend along one half of the measurement area, to measure the whole parcel.

In order to determine the maximum height of the object, a user could place the highest portion of the top of the parcel under the height sensor, e.g. which e.g. may be at the centre of the measurement area, e.g. over the centre of the turntable. Alternatively, a number of height sensors could be used to check the object height at a number of positions across the measurement area. Rotation of one or more sensors or scanning of a sensor beam, e.g. a laser beam, could also achieve this. In a further alternative, a height sensor may be able to sense over a wide area of the measurement area. In one embodiment, for example, the height sensor may be an ultrasonic sensor that emits an ultrasonic beam that spreads out in a cone, the top of the object would then reflect the beam, and the resulting signal will indicate a maximum height for the portion of the object that lies within the cone.

In one preferred embodiment, the sensing apparatus includes an ultrasonic sensor for sensing height, and a laser sensor for sensing a cross-sectional profile.

In another possible embodiment, the object dimensions could be obtained by one or more camera sensors, e.g. video cameras. Thus, a camera may provide an image that can then be analysed to identify the boundaries of the object in the image, and suitable calculations may then be made to determine the actual dimensions. This embodiment could rotate the camera and object relative to one another to provide a suitable number of images from different directions so as to provide a three dimensional profile, or could use a number of cameras located at different positions around the measurement area. The various camera images may overlap one another in order to ensure full coverage of the object. The camera or cameras may be located so as to provide a perspective view of the object, e.g. by being located above and to the side of an object measurement position.

It should be noted that the control apparatus, and the control steps carried out by it, may be implemented in any suitable form, e.g. through suitable software, firmware and hardware, as would be readily understood by a person skilled in the art.

The present invention extends to computer software for determining a dimensional weight of an object, the software including a component for receiving actual weight data of an object, a component for receiving size data for the object, a component for determining a dimensional weight for the object based on the size data, and a component for outputting weight data for the object based on the actual weight data and the dimensional weight. The software may include a component for determining a volume for the object from a determined cross-sectional area of the object and a height measurement of the object. It may determine the cross-sectional area as the area of a minimum-area polygon, e.g. square or rectangle, that will enclose a measured cross-sectional profile of the object.

The present invention also extends to a method of dimensional weighing or cubing using any of the above apparatus and features, and, viewed from another aspect, the present invention provides a method of determining the dimensional weight of an object, the method including the steps of using one or more sensors to obtain size data of an object (e.g. as it is weighed on a set of scales), using the size data to determine a dimensional weight of the object, intercepting actual weight data of the object from a set of scales, and outputting weight data to a pricing apparatus based on the actual and dimensional weights.

The present invention also extends to a method of determining the dimensional weight of an object, the method including the steps of providing a turntable on weighing apparatus, e.g. a set of weighing scales, and using one or more sensors to obtain size data of the object as it is rotated on the weighing apparatus during the weighing process, obtaining the size data and the output of the weighing apparatus in order to determine a dimensional weight and an actual weight of the object, and outputting weight data to a pricing apparatus based on the actual and dimensional weights.

Viewed from a further aspect, the present invention provides weight determining apparatus including sensing means for determining a dimension of an object to be weighed, and a control means which in use connects between a weighing apparatus for weighing the object and a pricing apparatus for pricing the object based on the weight, the control unit determining a weight value for the object based on the output of the weighing apparatus and the output of the sensing means, and outputting the weight value to the pricing apparatus.

Viewed from another aspect, the present invention provides a parcel cubing and weighting unit for use with a set of scales and a pricing terminal, the unit including an interface for communicating with the pricing terminal, an interface for communicating with the set of scales, one or more sensors for obtaining size data of a parcel, and a control for reading an actual parcel weight from the scales interface, for determining a size-equivalent weight based on the size data, and for outputting one of the two weights through the pricing terminal interface.

Viewed from a further aspect, the present invention provides dimensional weighing apparatus, which in use intercepts weight data that is output from scales for measuring the actual weight of an object and that is meant for receipt by a pricing terminal, and outputs to said pricing terminal either the actual weight data or dimensional weight data that is determined by the apparatus for the object.

The analysis of a profile of measured sensor readings to provide a cross-sectional area for an object is in itself an important feature, and, viewed from another aspect, the present invention provides dimensional weighing apparatus including sensor means for obtaining a profile of distances between a reference point and the surface of an object in a cross-sectional plane of the object in a number of angular directions, and means for analysing the profile, in order to determine dimensions of the object in that cross-sectional plane. Preferably, the reference point is the centre of an object measuring area. The apparatus may determine a cross-sectional area for the object based on the analysis of the profile. The cross-sectional area may be multiplied by a detected height of the object to provide a volume for the object.

The analysis may include a determination of peaks and/or troughs of the profile. It may also include a determination of a minimum-area polygon, e.g. square or rectangle, which will contain the detected profile.

The present invention need not only be provided as a retrofit system that can be placed between existing weighing and pricing apparatus, and may incorporate either or both weighing and pricing actions into the same apparatus. For example, the present invention may provide apparatus that both weighs and sizes an object before outputting the result to a pricing apparatus, and could further include pricing apparatus so as to output a final price.

Viewed from a further aspect, the present invention provides dimensional weighing apparatus including weighing apparatus for weighing an object, sensor apparatus for providing information on the size of the object, and a controller for determining a dimensional weight of the object based on the size information and for determining the actual weight of the object from an output of the weighing apparatus.

In one preferred form of this aspect, the object and sensor apparatus are rotated relative to one another in order to obtain the size information, preferably during weighing. In another embodiment, that need not rotate the object, the sensors may include one or more cameras that take an image or images of the object that may be digitised and analysed to identify object edges and determine object dimensions. In one preferred embodiment, the apparatus determines a cross-sectional profile of the object, preferably through 360 degrees, and further preferably the apparatus determines a minimum area polygon into which the cross-sectional profile fits. The cross-sectional area is preferably multiplied by a height of the object to obtain an object volume.

The rotation of the object, especially during weighing, is a particularly useful feature of the present invention, and, viewed from a further aspect, the present invention provides dimensional weighing apparatus including means, e.g. scales, for weighing an object, one or more sensors for providing information on the size of the object, means for rotating the object and the sensors relative to one another, preferably during weighing, and a controller for determining a dimensional weight of the object based on the sensor information and for determining the actual weight of the object from an output of the weighing means.

Viewed from a further aspect, the present invention provides dimensional weighing apparatus including apparatus, e.g. scales, for weighing an object, a turntable for rotating the object, one or more sensors for providing information on the size of the object as the object is rotated on the turntable, and a controller for determining a dimensional weight of the object based on the sensor information and for determining the actual weight of the object from an output of the weighing apparatus.

Viewed from a still further aspect, the present invention provides dimensional weighing apparatus including apparatus, e.g. scales, for weighing an object, one or more sensors for providing information on the size of the object, apparatus for rotating the sensor or sensors so as to provide information on a 360 degree profile of the object, and a controller for determining a dimensional weight of the object based on the sensor information and for determining the actual weight of the object obtained from an output of the weighing apparatus.

The apparatus and methods discussed above need not be limited to use in postal counter situations and the like, but may also for example be employed by users of mail services and the like, e.g. to provide information on the likely costs of their mailings.

In a particularly preferred embodiment, the apparatus and methods may be used by a mail customer in a docketing system to obtain a mailing docket or the like, the docket providing information on the parcel, including e.g. the cost of postage (as determined by dimensional weighing) and/or the actual volume of the parcel itself.

In another preferred form, the apparatus and methods are used in a franking system in which the user is able to price and pay for the parcel from their premises.

Thus, data from a customer cubing apparatus may be sent to docketing/franking means which may in turn output data for the printing of a parcel docket or stamp and e.g. for recording in a customer's mail record system. The system may be provided as a single dedicated unit, or may be made up of separate parts, e.g. the cubing apparatus itself, a dedicated franking unit, and e.g. a personal computer and printer. The franking means could also be provided as software in the personal computer.

In one preferred embodiment, the information from the docketing and/or franking system is sent to a central control, e.g. a server, e.g. through a direct dial-up or the Internet, e.g. through a web-site. The central control may then use this information to provide various services, e.g. to track parcels and provide other auditing services and to bill the customers.

In another preferred embodiment, the franking procedure itself may be conducted in co-operation with a central control, e.g. over the Internet, e.g. through a secure server, and a customer may pass cubing information from its own dimensional weighing apparatus to the central control of the parcel delivery service, the central control then providing instructions/authorisation to the customer to print a docket/frank a parcel in accordance with the cubing information.

Billing could take place on a parcel-by-parcel basis, or at set periods, e.g. weekly/monthly, e.g. through a download from or inspection of the franking means or through a look-up of the central control's records.

The docket may take any suitable form, e.g. an adhesive label, and may include any suitable information, such as the parcel's origin, its destination, its cubic weight and/or volume, the time and date of printing, and the postal charge.

The docket may include a PIN number associated with the parcel itself, and/or with the particular cubing or franking apparatus used in the procedure (this may provide parcel origin information).

The docket/franking information may be encrypted so as to reduce the possibility of forgery.

The information in the docket may be recorded in any suitable manner, e.g. in the form of a bar-code.

An important feature of the docketing/franking system is the ability to accurately identify the parcel from the docket/franking information. This then allows other services to be provided that are based on the ability to uniquely identify the parcels. The provision of the actual parcel volume facilitates this unique labelling, and can for example prevent a parcel passing through the system with the wrong docket (either through accident or deception) by checking the weight/volume of a parcel with that recorded on its docket, e.g. through a further cubing apparatus.

Viewed from a further aspect, the present invention provides a system for monitoring parcels including dimensional weighing apparatus provided at a plurality of customer and parcel delivery service locations, means for placing a label on a parcel at a customer's location based on information from the customer's dimensional weighing apparatus, and means for reading the label at the parcel delivery service locations.

It should be noted that any of the aspects mentioned above may include any of the features mentioned in relation to any of the other various aspects of the present invention.

Embodiments of the present invention will now be described, by way of example only, with reference to the accompanying drawings. It is to be understood that the particularity of the drawings does not supersede the generality of the preceding description of the invention.

In the drawings:

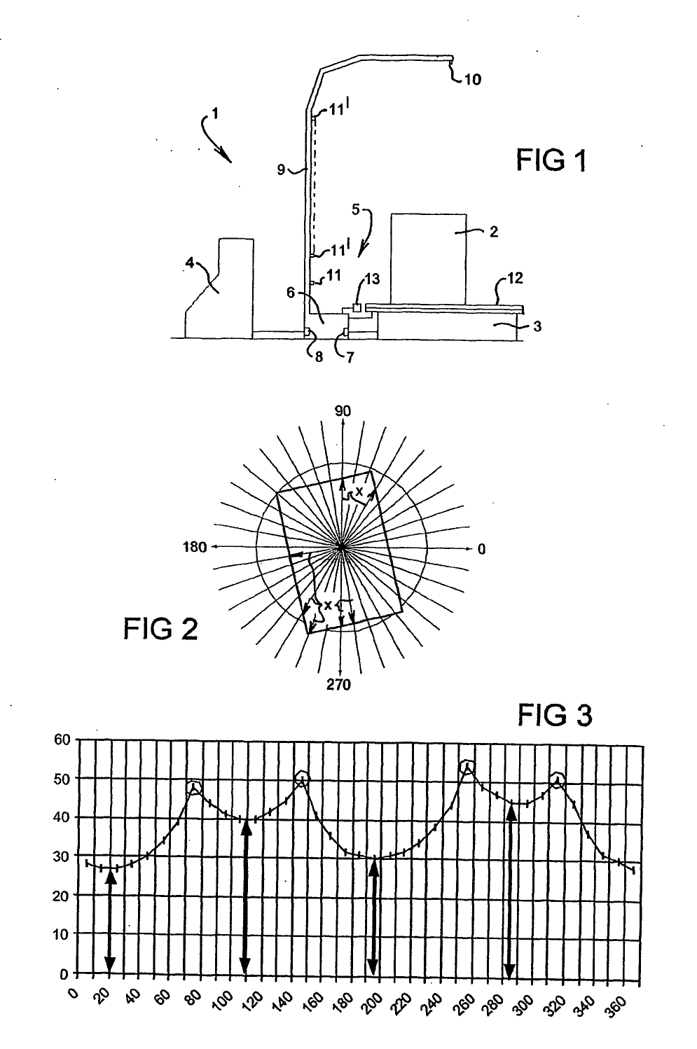

FIG. 1 is a schematic side-view of a cubing and weighing system in accordance with one embodiment of the present invention;

FIG. 2 is a top view of a parcel on the scales of the system of FIG. 1, showing the dimensions of a parcel's profile that are measured by a horizontal sensor of FIG. 1;

FIG. 3 is a graph of the sampled output of a horizontal sensor of FIG. 1 plotted against rotational angle of the parcel;

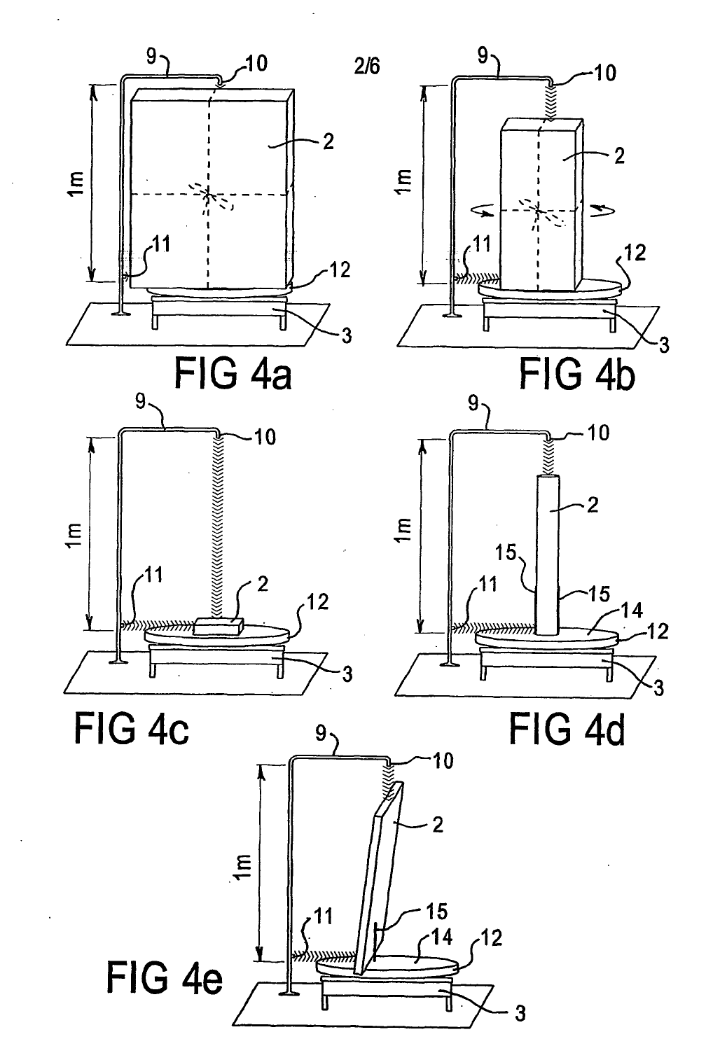

FIGS. 4a-4e show parcels of varying shape being weighed by the system of FIG. 1;

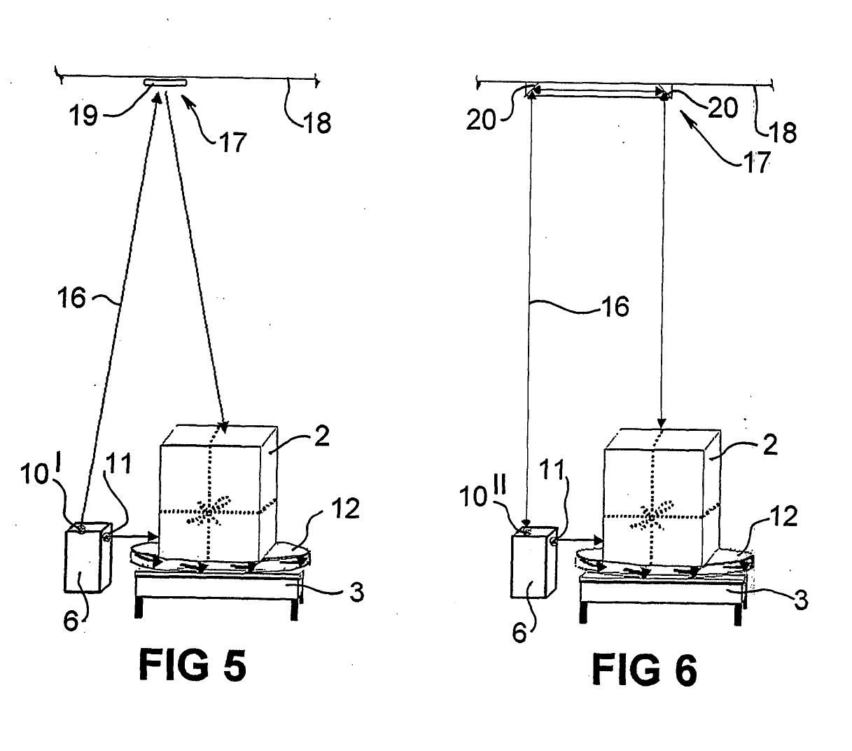

FIG. 5 is a schematic side-view of a cubing and weighing system in accordance with a second embodiment of the present invention;

FIG. 6 is a schematic side-view of a cubing and weighing system in accordance with a third embodiment of the present invention;

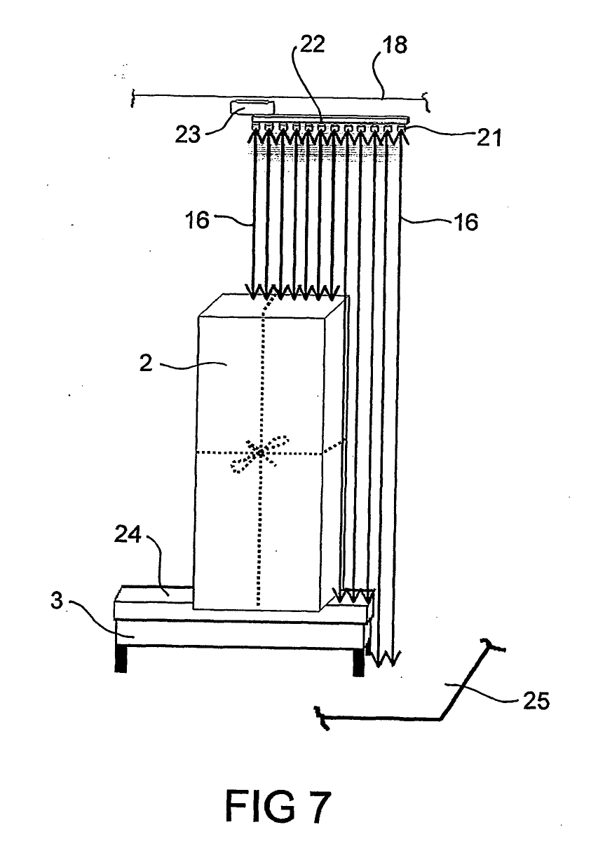

FIG. 7 is a schematic side-view of a cubing and weighing system in accordance with a fourth embodiment of the present invention;

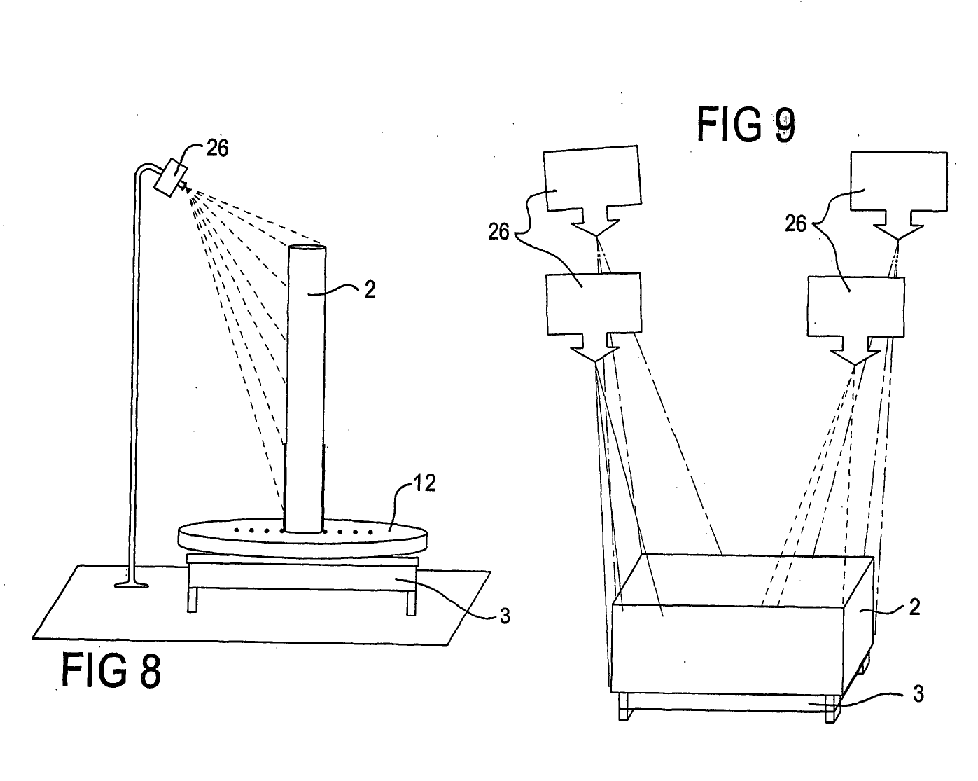

FIG. 8 is a schematic side-view of a cubing and weighing system in accordance with a fifth embodiment of the present invention;

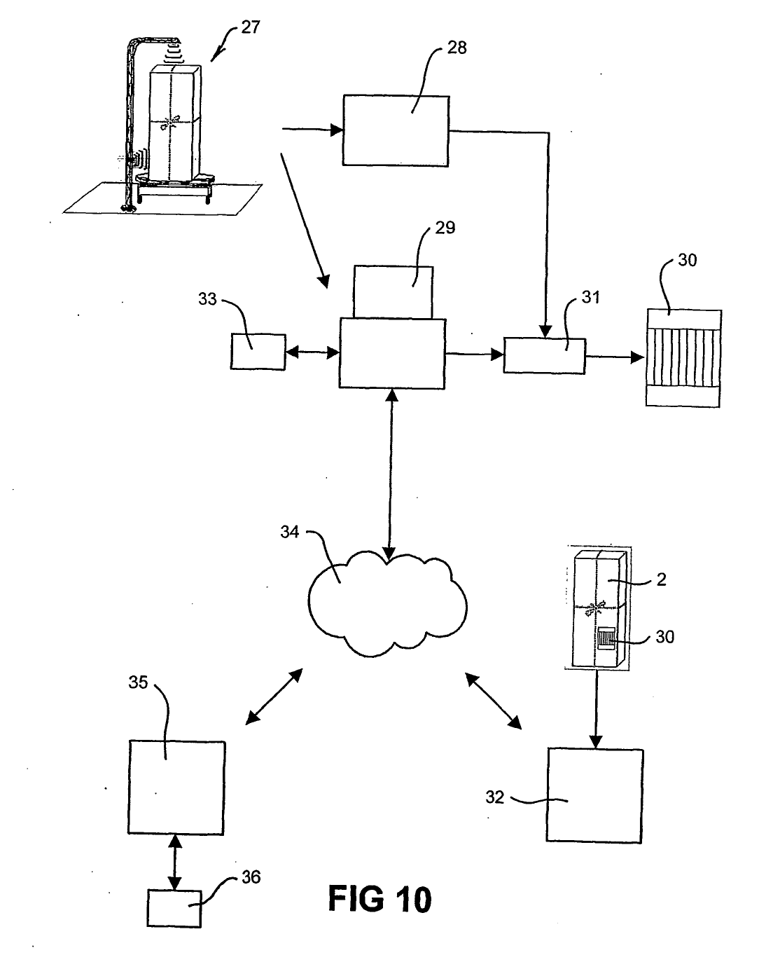

FIG. 9 is a schematic side-view of a cubing and weighing system in accordance with a sixth embodiment of the present invention; and

FIG. 10 is a schematic diagram of a parcel franking and docketing system in accordance with another embodiment of the present invention.

A system 1 for cubing and weighing a parcel 2 is shown in FIG. 1. Such a system may be used in e.g. a postal retail outlet, such as on a post office counter.

The system 1 may be provided either as a complete system, or in a retrofit manner using the weighing scales 3 and/or cash register 4 (or other point-of-sale/epos terminal) that are already on site.

In a standard postal counter system, when a parcel 2 is placed on the scales 3, the scales 3 outputs the parcel's weight continuously in ASCII code. The cash register 4 reads the weight data from the scales 3, and determines a suitable postage charge for the parcel 2.

The postage charge is based on the weight of the parcel, and also on other parameters manually input to the cash register 4. These parameters may include for example whether the parcel 2 is for domestic or international carriage, whether the parcel is to go by sea or air, and on e.g. premiums relating to recorded or registered delivery or the like.

The parcel 2 should also be priced based on its volume, e.g. according to the “cubing” or “dimensional weight” concept. Thus, an equivalent weight should be assigned to the parcel based on its volume and on a minimum chargeable weight per unit volume factor, and the heavier of the actual or equivalent weight should be used in charging. This step however is often not performed due to the lack of suitable equipment for aiding postal workers to determine the equivalent or dimensional weight.

The present invention addresses this problem, in the retro-fit embodiment, by providing cubing apparatus 5 that may be transparently installed between the scales 3 and the cash register 4 to facilitate the dimensional weighing of the parcel 2, i.e. the pricing of the parcel based not only on weight but also on size.

The cubing apparatus 5 includes a control unit 6 having an interface 7 for communicating with the scales 3 and an interface 8 for communicating with the cash register 4. These may for example take the form of RS232 interfaces.

The cubing apparatus 5 also includes a support stand 9, e.g. of an inverted substantially L- or J-shaped configuration, on which are mounted an overhead vertically-oriented sensor 10 located above the centre of the scales 3 for measuring the height of the parcel 2, and a horizontally-oriented sensor 11 for obtaining data on a cross-sectional profile of the parcel 2.

The sensors 10 and 11 are of a non-contact type, and may comprise for example ultrasonic, microwave or laser sensors. They include transmitters that emit sensing beams, and receivers that detect the emitted beams after they have been reflected back by the parcel 2. They may determine the distance between themselves and a portion of the parcel 2 that lies within their line of sight. Distance determination may be made using e.g. a time of flight or interferometric method.

The cubing apparatus 5 further includes a turntable 12 that is mounted on the scales 3, e.g. by adhesive or other suitable means, and that rotates the parcel 2 so that the horizontal sensor 11 may sense a full 360-degree profile of the parcel 2. The scales 3 should be re-calibrated to take account of the turntable weight.

The turntable 12 is controlled by the control unit 6, and is triggered to rotate by the control unit 6 when the control unit 6 starts to receive weight data from the scales 3 (as this indicates that a parcel 2 is on the scales 3). At the same time, the control unit 6 also triggers the sensors 10 and 11 to begin sensing.

Once the control unit 6 has recorded the distance measurement from the vertical sensor 10, it switches that sensor off, as only one reading is required. In order to build up a full 360-degree horizontal cross-sectional profile of the parcel 2, the control unit 6 continues to read the output of the horizontal sensor 11 for a full 360-degree rotation of the turntable before switching off both the turntable 12 and the horizontal sensor 11.

In order to correlate the data from the horizontal sensor 11 with the position of the parcel 2, the turntable 12 includes a position encoder 13. The encoder 13 outputs a pulse to the control unit 6 each time that the turntable 12 has rotated a set number of degrees. The encoder 13 may comprise an optical or magnetic encoder, as are known in the art, and e.g. may comprise a series of optical or magnetic elements mounted on the base of the rotating portion of the turntable, and an optical or magnetic sensor which outputs a pulse each time an element passes over it.

The control unit 6 uses the encoder pulses to sample the readings from the horizontal sensor 11, and so to correlate the position of the parcel 2 with the readings.

The speed of the turntable 12 and the resolution of the recorded profile will depend on the type of sensor 11 used. For example, a laser sensor may have a 1-degree resolution, whilst an ultrasonic sensor may have a 10-degree revolution. Thus, for an ultrasonic sensor, the control unit 6 may take readings every 10 degrees of rotation, and the encoder 12 may accordingly output pulses at each ten-degree rotation of the turntable 12. A full rotation may be achieved in e.g. about 4 seconds.

In order to determine the postage charge for a parcel 2, a user, e.g. a postal worker, places the parcel 2 on the scales 3, and, after waiting a short time for a 360-degree rotation of the turntable 12, reads the resulting charge for the parcel 2 from the register 4. The whole system is thus automatic and transparent to the user, and allows them to quickly and easily implement a cubing and weighing system, thereby generating increased income for the postal company involved.

Viewed from the apparatus side, once a parcel 2 is placed on the scales 3, the scales 3 will continually output the actual weight of the parcel 2 in ASCII code. The control unit 6 will note, through a change on the input of interface 7, that the scales 3 have begun an output, and will trigger the turntable 12 to rotate and the sensors 10 and 11 to begin to take readings.

The control unit 6 will then record the weight of the parcel from the output of the scales 3, and also the height of the parcel 2 from an output of the overhead sensor 10, and turn that sensor off.

The sensor 10 need only provide one reading, which the control unit 6 can then use to determine parcel height by reading the distance of the parcel from the sensor 10 and by subtracting this from the distance between the top of the turntable 12 and the sensor 10. This latter distance can be preset at e.g. 1 meter or just over this value (so as to provide a 1 m high sensing region), and may be measured exactly by the sensor 10 in an initialisation reading taken when no parcel is on the scales 2.

The control unit 6 also samples the output of the horizontal sensor 11 at set rotations of the turntable 12, as indicated by the pulses from the encoder 13.

These outputs allow the control unit 6 to determine the distances “X” shown in FIG. 2 between points on the outer periphery of the parcel 2 and the centre of the weighing scales 3. The control unit 6 obtains these measurements by reading the measured distance to the parcel 2 and by subtracting this from the known distance between the sensor 11 and the centre of the turntable, which is preset at e.g. 50 cm or just over this value (so as to provide a 1 m² horizontal measurement region).

Once the turntable 12 has turned through 360 degrees, the control unit 6 stops the turntable 12 and the sensor 11, and, if the parcel 2 is of oblong shape will have recorded a cross-sectional profile similar to that shown in FIG. 3.

The control unit 6 then analyses this profile in any suitable manner in order to obtain the dimensions and/or area of the parcel cross-section, and then obtains the parcel volume by multiplying the dimensions/area by the calculated height of the parcel.

In one embodiment, in order to analyse the profile, the control unit 6 may first identify and determine the number of peaks and/or troughs in the profile. These will correspond to the parcel corners and the centres of the parcel sidewalls. As the sensor readings may not correspond exactly with the corners or centres of the parcel sides, the control unit 6 may carry out interpolation, extrapolation and/or curve-matching on the obtained sensor data in order to determine values for the peaks and troughs.

The control unit 6 may determine the shape of the parcel's cross-section from an analysis of the peaks and troughs, e.g. a straight line (zero peaks or troughs) would indicate a cylinder, and four peaks and four troughs would indicate a rectangle. The control unit 6 may then correlate the dimensional measurements for the peaks and/or troughs with one another, e.g. add them together, and use simple geometric relationships to determine dimensions of the cross-section. For example, the control unit 6 could add “opposing” trough dimensions of an oblong profile to give a width or length of the parcel 2 (in the case of an oblong shape, “opposing” troughs would be each alternate trough).

In another embodiment for analysing the profile, the control unit 6 may determine a minimum-area polygonal shape, such as a square or rectangle, that encompasses the data points of the profile. When the polygon area is then multiplied by the maximum parcel height, the apparatus provides a parcel volume and dimensional weight that is based on the size of the smallest polyhedron, e.g. a cube or cuboid, that will contain the parcel. This embodiment is of particular use for coping with irregularly shaped parcels.

The minimum-area polygonal shape is obtained, in one embodiment, by firstly organising the data in the manner of a “convex hull”. This then discards internal body points. Co-linear points are then normalized to remove redundancies. A bounding rectangle algorithm is applied to each convex-hull dimension in turn, and from the generated bounding rectangles, the minimum bounding rectangle is chosen as the minimum-area polygonal shape with which to calculate the parcel volume.

The data from the height and cross-sectional profile sensors may be processed prior to the various mathematical calculations, e.g. to reject spurious data, such as spikes and the like, and to conduct sanity checks against expected voltage levels. The data can be converted into actual measurements e.g. in centimetres via e.g. suitable conversion functions.

Once the control unit 6 has determined the parcel volume, it calculates an equivalent minimum weight by using an appropriate weighing factor or look-up table, and then compares this weight with the actual weight. Whichever of the two weights is the heaviest is then output via interface 8 to the cash register 4. The output data is presented in the same manner as the cash register 4 would expect to receive weight data from the scales 3, e.g. as a continuous output of the weight data in ASCII format.

The cash register 4 then calculates a postal charge for the parcel using the received weight data and the register's standard pricing algorithms.

It should be noted that a user does not need to precisely locate the parcel 2 at the centre of the turntable 12, since by obtaining a full 360-degree cross-sectional profile of the parcel 2, any off-centre placement is automatically taken into account.

The system described assumes that the cross-sectional profile will be constant throughout the height of the parcel 2. This will generally be the case, as the vast majority of parcels are cubic or oblong in shape, and other common shapes such as cylinders and the like are also accommodated. Even where a parcel is not of such a regular shape, a cubing system will often require that the price be based on a cube determined from the longest dimensions of the parcel in the height, width and breadth directions. The system will therefore generally accommodate such systems.

In order to obtain the maximum parcel height, the user may place the highest part of the parcel directly below the height sensor 10. Alternatively, the sensor 10 may be able to sense over a wide area of the measurement region. Thus, the sensor 10 may be an ultrasound sensor whose beam may spread out in a cone. It will then be able to obtain a maximum height over the area of the parcel that the cone intercepts.

If more detailed information on parcel volume is required, then for example extra horizontal sensors 11′ could be added one above the other to provide cross-sections at various parcel heights. The largest profile could then be used to calculate the volume, or all or some of the profiles could be combined to more accurately calculate the actual volume of the parcel or to take an average of the values, or to produce a profile that incorporates the largest dimension from all of the profiles for each angular direction.

Also, further vertically-oriented sensors 10, e.g. an array of sensors along a radius of the measurement area within which the parcel turns, could be provided, and the highest reading could be used as the parcel height or a height profile of the parcel could be calculated.

FIGS. 4a-4e show various sized and shaped parcels 2 placed on the turntable 12. As shown in FIGS. 4d and 4e, the turntable 12 may include suitable supports for holding awkwardly-shaped parcels in position, e.g. the turntable 12 may include a set of holes 14 into which support pins 15 or the like may be placed. Although not shown, a centring guide for placing the parcel centrally on the turntable could also be provided, although, as said, with the 360 degree profile of the parcel, centring is not a necessity.

The actual measuring area covered by the sensors could take any suitable size or form, but is preferably a cubic region preferably of about 1 m×1 m×1 m.

The use of a measuring area of a set size has the added advantage that it limits the size of the parcels that can be passed over the counter. This can result in significant savings for the parcel carrier, because parcel systems are generally designed to work with standard sizes, e.g. a 1 m³ cube or less, and parcels over this size need special handling often at high cumulative cost. The present system provides a physical barrier to anyone wanting to post parcels outside of the sensor size range, so that they can then be instructed on what alternative course of action to take, e.g. to take the oversize parcel to a specific parcel-handling centre.

As shown in this first embodiment, the weighing area is preferably provided within the measuring area. This allows weighing and sizing to take place at the same time and helps to save counter space.

It should be noted that the control process carried out by the control unit 6 may be implemented in any suitable form, e.g. in the form of suitable software, firmware and hardware, e.g. using a suitable microprocessor or the like.

Second and third embodiments of cubing apparatus according to the present invention are shown in FIGS. 5 and 6, in which the overall cubing system is similar to that of the FIG. 1 arrangement, but in which the height sensors 10′ and 10″ are not mounted overhead of the parcel 2. Instead, they are mounted within the housing of the control unit 6, along with the horizontally-oriented cross-section sensor 11, and are oriented so as to fire their beams 16 upwardly to a reflector 17 mounted on the ceiling 18 of the room in which the apparatus is located. The reflected beam then follows the reverse path back to the sensor 10′,10″ for detection. In this case, the sensors 10′,10″ may emit laser beams, and these may, if desired, scan across the measurement area to obtain a maximum parcel height.

In the FIG. 5 embodiment, a single mirror 19 is used to reflect the beam 16 onto the parcel 2, and the height sensor 10′ emits the beam 16 at a slight angle to the vertical. The beam 16 will broaden out on travelling to the parcel 2, and a portion of the beam will reflect back to the sensor.

In the FIG. 6 embodiment, the reflector 17 comprises a pair of opposed mirrors 20 arranged at 45 degrees to the vertical in a periscope-type manner, and the height sensor 10″ emits the beam 16 vertically upwardly, the beam 16 reflecting off of both of the mirrors 20 so as to be incident vertically on the top of the parcel 2.

In each case, the reflectors 17 can be of lightweight construction, so that no significant supporting structure is required, and they may be mounted on the ceiling 18 using e.g. adhesive, screws, or the like. Of course, the reflectors 17 could also be provided on suitable supporting structures intermediate the parcel measuring area and the ceiling, e.g. on brackets from an adjacent wall or the like.

These embodiments are able to provide a particularly compact and simple design, in which the control unit 6 and sensors 10′,10″,11 can have a small footprint, and little impact on counter space.

FIG. 7 illustrates a fourth embodiment of the cubing apparatus of the present invention, which again may be used in a similar overall structure to that shown in the first embodiment, so as to provide a cubing device transparent to the scales 3 and cash register 4.

In this embodiment, there is no horizontally-oriented sensor 11, and no turntable 12. Instead, a linear array of height-measuring sensors 21 is mounted above the parcel 2 on a rotating arm 22.

The rotating arm 22 is connected to an electric motor 23 mounted on the ceiling 18 of the room in which the apparatus is located (Again, mounting could take place using any suitable supporting structure and bracketing at any point intermediate the parcel sensing area and the ceiling).

Each sensor 21 will either record a height of the parcel 2 where it intersects the beams 16, or will record the distance to one or more default surfaces, such as the top 24 of the scales 3 and/or the top 25 of the post office sales counter or the like.

As the arm 22 rotates, the first of the sensors 21 (from the inner sensor outwards) that records a distance equal to or greater than the distance to the scales top 24 will indicate that the edge of the parcel 2 has been reached, and so a dimension of the parcel 2, i.e. the distance of the relevant sensor 21 from the centre of rotation, can be recorded for that particular angle of revolution of the arm 22. In this way, a profile similar to that of FIG. 3 can be built up as the arm 22 rotates. The measurements will be to a resolution determined by the spacing of the sensors 21 from one another.

The outputs of the sensors 21 may be provided to a control unit 6 by suitable cabling or preferably through wireless communication.

Similar processing to that described in FIG. 1 can be carried out to provide a cross-sectional area of the parcel 2, and one or more of the height sensor readings of the parcel 2 can be used with the cross-sectional area to provide the parcel volume.

If the cross-sectional area of the parcel is irregular along its length, the above procedure will record a cross-sectional area corresponding to the largest cross-sectional dimension of the parcel at each angular measurement, and effectively calculates a minimum parcel volume for a shape of constant cross-section within which the actual parcel would fit. The apparatus may determine the cross-sectional area based on a standard shape, e.g. a cylinder, square, other polygon or the like, or may use an irregular shape corresponding to the actual maximum dimensions of the object in each angular direction.

The height reading used may be the highest value recorded, or an average of the height readings, or may be based on any other suitable processing of the height sensor outputs.

This embodiment has the advantage that little extra counter space need be taken up with the cubing apparatus, and that the parcel need not be rotated.

FIG. 8 illustrates a fifth embodiment of the present invention in which the horizontal and vertical sensors are replaced by a camera sensor 26, e.g. a video camera, that is provided above and to one side of the parcel location on the turntable 12. The camera may be a digital camera and provide digital images, or may be analogue, in which case the images output by it may be suitably digitised. The digital images may be analysed by suitable analytical software in the control unit 6 to determine features of the parcel 2, e.g. its edges. The parcel dimensions can then be determined from an analysis of the positions of the parcel features in the images. A suitable number of images can be taken as the turntable 12 rotates so as to provide a full 360 degree representation of the parcel. The images may overlap one another.

FIG. 9 illustrates an embodiment similar to that of FIG. 8, but in this case no turntable is used, and, instead, a plurality of camera sensors 26, e.g. four cameras, are used. The cameras 26 in this embodiment are provided at four corners of a square or rectangle so as to provide a correspondingly shaped measurement area below them and between them. The camera images may each overlap to ensure full coverage of the measurement area.

Although mainly discussed above with respect to their use at postal counters, the cubing apparatus of the present invention could be used in any other suitable situations, and could for example be used by a customer of a postal service at the customer's premises.

Thus, the customer could use the apparatus to determine the cost of their mailings and the like.

The present invention could also be used in providing a customer with a franking and docketing system. Such a system is shown schematically in FIG. 10.

In this embodiment, the cubing apparatus 27, which could take any of the above-mentioned forms, provides the dimensional weight data to a dedicated franking device 28.

The franking device 28, which may be provided by the appropriate postal service used by the customer, will determine the correct postal charge based on the postal service tariffs and the dimensional weight, and outputs this charging information to a personal computer 29 of the customer. The personal computer 29 will note the charging information, and will issue a label 30 via a printer 31 corresponding to the postal charge.

The label 30 is applied to the parcel 2 and is used as proof of postage paid, when the parcel 2 is presented to the mail service via e.g. an appropriate postal outlet 32.

The personal computer 29 may also receive further information from the franking machine 28, such as the actual volume of the parcel 2, and the type of mail service required, e.g. airmail, recorded delivery or the like (which the customer will have input into the franking device for pricing purposes).

The personal computer 29 may alternatively receive such information directly from customer inputs (which it could output to the franking machine 28), and may receive the volume information directly from the cubing apparatus. It may also receive further information from the customer, such as the actual destination of the parcel and any other desired information.

The personal computer 29 may use the input information to update a customer database 33 of mailing orders, and may also print any or all of the information onto the label 30.

Other connections are also possible, for example the franking device 28 may send printing instructions to the printer 31 directly, or could include the printer therein. It may still send information to the computer 29, so as to update the database 33, etc.

The customer may be billed in any suitable manner, e.g. through a reading or recharge of a billing meter in the franking device 28. This could be done e.g. through a manual inspection or through an on-line connection with a billing agent.

The postal outlet 32 is able to ensure that the correct price etc., has been paid through a scan of the label 30 and by conducting its own check using similar cubing apparatus. The parcel 2 may then be mailed as normal.

By using the information that may be provided on the label 30, which is able to uniquely identify the parcel 2, and by using e.g. an Internet connection 34, the system may be extended so that the customer, the postal outlets 32 and a central postal control 35 can communicate with one another regarding the parcel 2, e.g. for audit purposes, tracking purposes, confirmation of receipt services, and/or any other suitable purpose that requires the identification of individual parcels 2.

For example, the customer may send a record of a label 30 to the central control 35, e.g. an Internet server, and the central control 35 may then enter the information into a database 36 of franked post. The postal outlets 32 may also pass information as to the parcels received by them to the central control 35, which may then monitor the movement of the parcels 2, e.g. to provide a tracking service to the customer.

The label 30 may take any suitable form, such as a bar-code, and the information may be encrypted, so as to deter forgers and the like.

A PIN or PINs may be included in the label 30. This may relate to the individual parcel itself, and/or to the cubing apparatus and/or franking machine used, e.g. in order to identify the source of the label.

Instead of using the franking machine 28, the PC 29 could run franking software, which could be updated e.g. by downloads from the central control 35.

Also, the franking software may run from the central control 35, with the personal computer 29 sending the parcel information to e.g. a secure web-site, and receiving suitable information/instructions for printing a valid parcel label 30.

Billing may also be conducted on-line.

It would also be possible only to print an ID on the label 30, with any further information, including e.g. postal charging information, being reported to and held centrally by the central control 35.

It is to be understood that various alterations, additions and/or modifications may be made to the parts previously described without departing from the ambit of the present invention, and that, in the light of the teachings of the present invention, the weighing and cubing system may be implemented in any suitable manner.

For example, in FIG. 1, the cubing apparatus 5 need not be provided as a retro-fit design, but could be provided as a complete system, in which case for example, the control unit 6 could be implemented in the cash register 4 or in the weighing scales 3, e.g. by suitable software or the like, and the turntable could be integral with the scales.

Also, the encoder 13 may output only one pulse per revolution, in which case the control unit 6 will sample the output of the sensor 11 at set time intervals and will correlate each sampled output to the parcel position based on the time the sample was taken and the speed of rotation of the turntable. The turntable 12 should in this case use suitable motor means that allow it to be rotated at a constant speed.

If a number of horizontal sensors 11 are provided, then an overhead sensor 10 may not be needed, as the height may be determined by the first sensor beam not crossed by the parcel.

Instead of rotating the parcel, the sensors could be mounted for rotation or both parcel and sensors could rotate. It would also be possible not to rotate the parcel or sensors, and instead provide sensors fully about the turntable.

The outputs of the vertical and horizontal sensors 10 and 11 could be suitably biased (by the sensors or control unit 6) by a voltage or the like corresponding to the distance to the top or centre of the turntable respectively, so that the sensor outputs read are the actual parcel dimensions, and so that no intermediate calculation is then required by the control unit 6 to obtain the parcel dimensions e.g. as height or as distance of parcel periphery from the turntable centre.

The sensor arrangement could also take other forms, such as the use of a video camera and identification software, or separately positioning transmission and reception portions of the sensing apparatus (the invention still providing e.g. a transparent means of providing cubing data between scales and a pricing terminal).

The sensors 10, 11 need not be mounted on the arm 9, and e.g. the horizontal sensor 11 could be free standing, whilst the vertical sensor 10 could be mounted on the ceiling area or a wall adjacent the postal counter or the like. The sensors 10,11 could communicate with the control unit 6 in any suitable manner, e.g. by cabling or by wireless connections.

These changes where applicable could also be applied to the other embodiments.

1. Dimensional weighing apparatus for use with object weighing apparatus and object pricing apparatus, the dimensional weighing apparatus including:
sensing apparatus for determining size data for an object to be weighed; and
control apparatus which receives size data from the sensing apparatus and which includes an interface for communicating with the weighing apparatus and an interface for communicating with the pricing apparatus;
the control apparatus in use being connected between the weighing and pricing apparatus, and outputting weight information to the pricing apparatus dependent on weight data from the weighing apparatus and size data from the sensing apparatus.

2. The apparatus of claim 1, wherein the control apparatus determines a dimensional weight for the object based on the size data, and outputs the larger of the dimensional weight and an actual weight of the object as determined from the weight data.

3. (canceled)

4. The apparatus of claim 1, wherein the sensing apparatus is adapted to determine the size of the object whilst the object is on the weighing apparatus.

5. (canceled)

6. The apparatus of claim 1, wherein the sensing apparatus includes non-contact type sensors.

7. The apparatus of claim 1, wherein the sensing apparatus includes sensors that sense a distance to the object.

8. (canceled)

9. The apparatus of claim 1, wherein the sensing apparatus includes one or more vertically-oriented sensors arranged in use over the object and/or one or more horizontally-oriented sensors.

10. (canceled)

11. The apparatus of claim 1, wherein the sensing apparatus and object rotate in use relative to one another.

12. The apparatus of claim 1, including a turntable on which the object is placed for size determination the turntable being adapted to be mounted in use on the weighing apapratus.

13. (canceled)

14. The apparatus of claim 12, wherein the turntable is connected to the control apparatus, and is activated by a signal from the control apparatus.

15.-17. (canceled)

18. The apparatus of claim 12, wherein the control apparatus correlates the size data with the rotational position of the turntable in order to determine a cross-sectional profile for the object.

19. The apparatus of claim 1, wherein the sensing apparatus provides data on at least one cross-sectional profile of the object and at least one height measurement of the object.

20. The apparatus of claim 1, wherein the sensing apparatus determines size data for a 360-degree profile of the object.

21. The apparatus of claim 19, wherein the control apparatus identifies the shape of the object through the peaks and/or troughs in the cross-sectional profile.

22. The apparatus of claim 21, wherein the control apparatus determines dimensions of the object cross-section based on the identified shape of the object, and on the dimension data for the object determined at the peaks and/or troughs of the profile.

23. The apparatus of claim 1, wherein the control apparatus determines cross-sectional profile data for the object and fits a minimum-area polygon to the profile data.

24.-27. (canceled)

28. The apparatus of claim 1, wherein the sensing apparatus includes one or more reflector elements for directing a sensing beam from a sensor onto an object to be measured.

29. (canceled)

30. Computer software for determining a dimensional weight of an object, the software including a component for receiving actual weight data of an object, a component for receiving size data for the object, a component for determining a dimensional weight for the object based on the size data, and a component for outputting weight data for the object based on the actual weight data and the dimensional weight.

31.-32. (canceled)

33. A method of determining the dimensional weight of an object, the method including the steps of using one or more sensors to obtain size data of an object, using the size data to determine a dimensional weight of the object, intercepting actual weight data of the object from a set of scales, and outputting weight data to a pricing apparatus based on the actual and dimensional weights.

34. The method of claim 33, including the step of providing a turntable on said set of scales, and obtaining said size date of the object as it is rotated on the weighing apparatus.

35.-37. (canceled)

38. Dimensional weighing apparatus including sensor means for obtaining a profile of distances between a reference point and the surface of an object in a cross-sectional plane of the object in a number of angular directions, and means for analysing the profile in order to determine dimensions of the object in that cross-sectional plane.

39.-40. (canceled)

41. Dimensional weighing apparatus including weighing apparatus for weighing an object, sensor apparatus for providing information on the size of the object, and a controller for determining a dimensional weight of the object based on the size information and for determining the actual weight of the object from an output of the weighing apparatus.

42. The apparatus of claim 41, wherein the object and sensor apparatus are rotated relative to one another in order to obtain the size information.

43. The apparatus of claim 41, wherein the sensor apparatus includes one or more cameras that take images of the object.

44. The apparatus of claim 41, wherein the controller determines a cross-sectional profile of the object.

45. The apparatus of claim 44, wherein the controller determines a minimum area polygon into which the cross-sectional profile fits.

46.-52. (canceled)
